(19) United States
(12) Patent Application Publication
(10) Pub. No.: US 2005/0103451 A1
(43) Pub. Date: May 19, 2005

(54) Bottom rail for window blind

(75) Inventor: Ming Nien, Changhua Hsien (TW)

Correspondence Address: BACON & THOMAS, PLLC, 625 SLATERS LANE, FOURTH FLOOR, ALEXANDRIA, VA, 22314, US

(73) Assignee: NIEN MADE ENTERPRISE CO., LTD., TAICHUNG (TW)

(21) Appl. No.: 10/827,302

(22) Filed: Apr. 20, 2004

(30) Foreign Application Priority Data
Nov. 13, 2003 (TW) 92220137

(51) Int. Cl. E06B 9/30

(52) U.S. Cl. 160/173 R

(57) ABSTRACT

A bottom rail for a window blind includes an elongated body and two end caps. The elongated body has two distal ends and two retaining portions respectively formed near the two distal ends. The two end caps are respectively fitted to the two distal ends of the elongated body. Each end cap has a retaining portion for engaging one of the retaining portions of the elongated body upon coupling of the end caps to the two distal ends of the elongated body.

### BACKGROUND OF THE INVENTION

1. Field of the Invention

The present invention relates generally a window blind and more particularly to a bottom rail for window blind.

2. Description of the Related Art

The conventional bottom rail of a window blind is generally comprised of an elongated main body and two end caps fastened to the two distal ends of the elongated main body. In order to reduce the manufacturing cost of the bottom rail and maintain its sense of beauty, plastic material is commonly used for making the bottom rail. Further, in order to reduce the weight, the main body of the bottom rail is made having a hollow structure by extrusion process. After formation of the main body of the bottom rail, the end caps are respectively plugged into the two distal ends of the hollow main body. Because the end caps are respectively plugged into the two distal ends of the hollow main body, they can easily be pulled apart from the hollow main body by a child plying the bottom rail for fun. Further, because the hollow main body is extruded from plastics, the end edges are sharp and may injure the user's hand accidentally. In addition, a young child may eat the end cap, which fell from the hollow main body accidentally.

### SUMMARY OF THE INVENTION

The primary objective of the present invention is to provide a bottom rail for a window blind, which ensures positive connection between the hollow main body and the end caps thereof.

To achieve this objective of the present invention, a bottom rail for a window blind comprises an elongated body and two end caps. The elongated body has two distal ends and two retaining portions respectively formed near the two distal ends. The two end caps are respectively fitted to the two distal ends of the elongated body. The end caps each have a retaining portion for engaging the retaining portion of the elongated body upon coupling of the end caps to the two distal ends of the elongated body.

### BRIEF DESCRIPTION OF THE DRAWINGS

FIG. 1 is an exploded view of a part of a bottom rail for window blind according to a first preferred embodiment of the present invention.

FIG. 2 is an assembly view of FIG. 1.

FIG. 3 is a sectional view of FIG. 2.

FIG. 4 is a sectional view of a part of a bottom rail for window blind according to a second preferred embodiment of the present invention.

FIG. 5 is an exploded view of a part of a bottom rail for window blind according to a third preferred embodiment of the present invention.

FIG. 6 is an assembly view of FIG. 5.

FIG. 7 is a sectional view of FIG. 6.

FIG. 8 is an exploded view of a part of a bottom rail for window blind according to a fourth preferred embodiment of the present invention.

FIG. 9 is a sectional assembly view of FIG. 8.

### DETAILED DESCRIPTION OF THE INVENTION

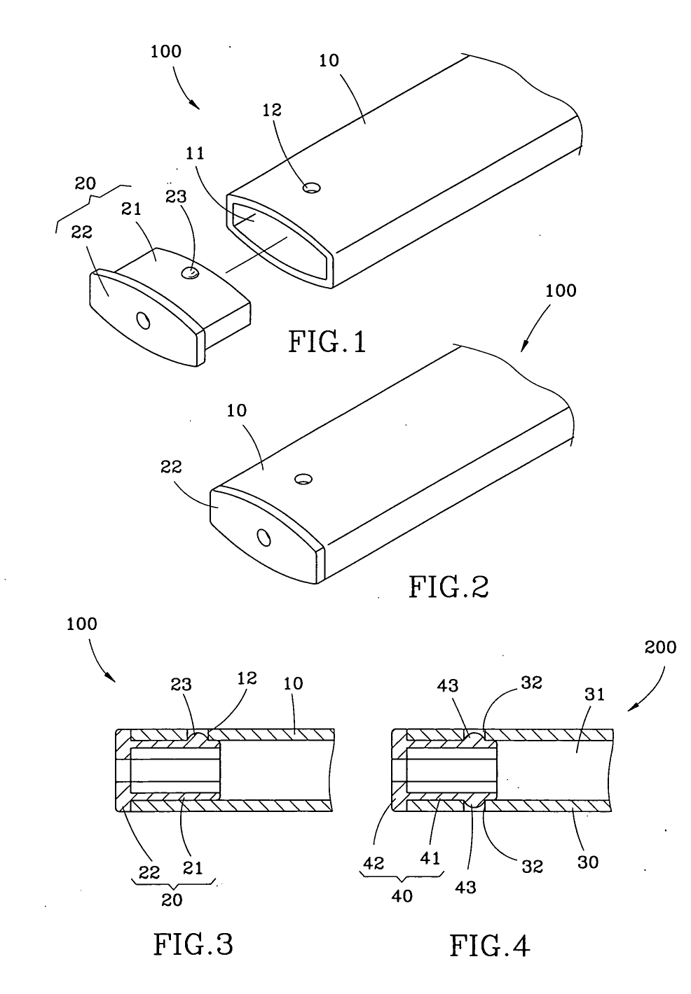

Referring to FIGS. 1-3, a bottom rail 100 for window blind in accordance with the first preferred embodiment of the present invention comprises a body 10 and two end caps 20 (only one end cap is shown in the drawings for briefly illustrative purpose).

The body 10 is an elongated hollow frame bar having an inside wall, a receiving chamber 11 defined by the inside wall and longitudinally extended through the two distal ends thereof, and two retaining portions 12 respectively formed near the two distal ends. It is to be noted that only one distal end and one retaining portion are shown in FIGS. 1-3 for illustration. According to this embodiment, the retaining portions 12 are round holes respectively formed in the top side near the two distal ends of the body 10 in communication with the receiving chamber 11.

The end caps 20 each comprise a head 22 and an insertion portion 21 perpendicularly extended from one side of the head 22. The insertion portion 21 has a cross section fitting the cross section of the receiving chamber 11, and a retaining portion, i.e. a rounded protrusion 23 raised from the top surface and adapted to engage the round hole 12 at one end of the body 10. The head 22 has a profile fits the cross section of the body 10.

During installation, the insertion portion 21 of the end cap 20 is press-fitted into the receiving chamber 11 of the body 10 to force the rounded protrusion 23 into the round hole 12 at one end of the body 10, as shown in FIG. 3. At this time, the head 22 of the end cap 20 is stopped at one end of the body 10 in a flush manner as shown in FIG. 2. It is to be understood that the two end caps 20 are identical such that they are respectively fastened to the two distal ends of the body 10 in the same way. Because the rounded protrusion 23 of each end cap 20 is respectively engaged into the round hole 12 at each end of the body 10 after insertion of the insertion portion 21 of each end cap 20 into the two distal ends of the body 10, the end caps 20 are firmly secured to the body 10 and will not fall from the body 10 when a child playing the bottom rail 100 for fun.

FIG. 4 is a sectional view of a part of a bottom rail according to the second preferred embodiment of the present invention. According to this embodiment the bottom rail, referenced by 200, is comprised of a body 30 and two end caps 40 (only one end cap 40 is seen in FIG. 4).

The body 30 is an elongated hollow frame bar having a receiving chamber 31 longitudinally extended through the two distal ends thereof, and two retaining portions 32 near the two distal ends (only one retaining portion is shown in FIG. 4). According to this embodiment, each of the retaining portions 32 is comprised of two round holes respectively symmetrically formed in the top and bottom sides near one of the two distal ends of the body 30 in communication with the receiving chamber 31.

The end caps 40 each comprise a head 42 and an insertion portion 41 perpendicularly extended from one side of the head 42. The insertion portion 41 has a cross section fitting the cross section of the receiving chamber 31, and a retaining portion, i.e. two rounded protrusions 43 respectively projected from the top and bottom surfaces and adapted to engage the round holes 32 at one end of the body 30. The head 42 has a profile fits the cross section of the body 30.

During installation, the insertion portion 41 of each end cap 40 is respectively press-fitted into the receiving chamber 31 of the body 30 from two sides to force the respective rounded protrusions 43 into engagement with the respective round holes 42 of the body 30. At this time, the head 42 of each end cap 40 is respectively stopped at the two distal ends of the body 30 in a flush manner. Because the rounded protrusions 43 of the end caps 40 are respectively engaged into the round holes 32 of the body 30 after insertion of the insertion portions 41 of the end caps 40 into the two distal ends of the body 30, the end caps 40 are firmly secured to the body 30 and will not fall from the body 30.

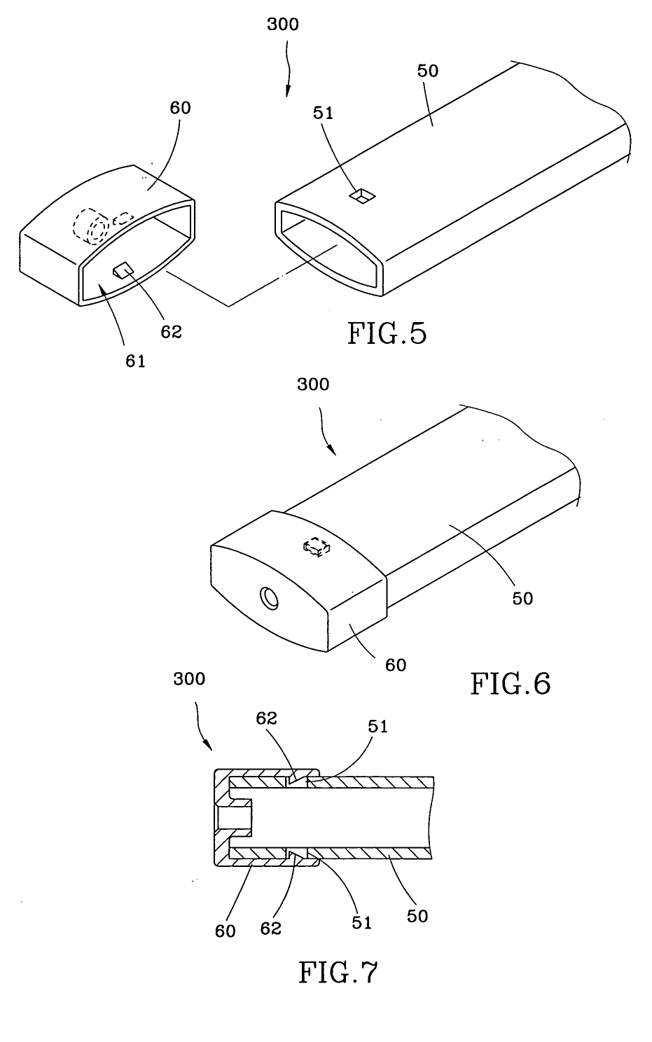

FIGS. 5-7 show a bottom rail constructed according to the third preferred embodiment of the present invention. According to this embodiment, the bottom rail, which is referenced by 300, is comprised of a body 50 and two end caps 60 (only one end cap 60 is seen in FIGS. 5-7).

The body 50 is an elongated hollow frame bar having two retaining portions 51 near the two distal ends (only one retaining portion and one distal end are shown in FIGS. 5-7). According to this embodiment, the retaining portion 51 includes two rectangular holes respectively symmetrically formed in the top and bottom sides near one of the two distal ends of the body 50.

The end caps 60 each comprise a receiving chamber 61 inwardly extended from one end (open end) toward the other end (close end) and fitting the cross section of the body 50, and a retaining portion, namely, two protruding blocks 62 raised from the inside wall and suspended in top and bottom sides inside the receiving chamber 61 corresponding to the rectangular holes 51 of the body 50. The protruding blocks 62 are beveled blocks sloping from the open end of the receiving chamber to the close end of the receiving chamber such that the protruding blocks 62 of the end caps. 60 are respectively engaged into the rectangular holes 51 of the body 50 when capped the end caps 60 on the two distal ends of the body 50, preventing the end caps 60 from escaping from the distal ends of the body 50.

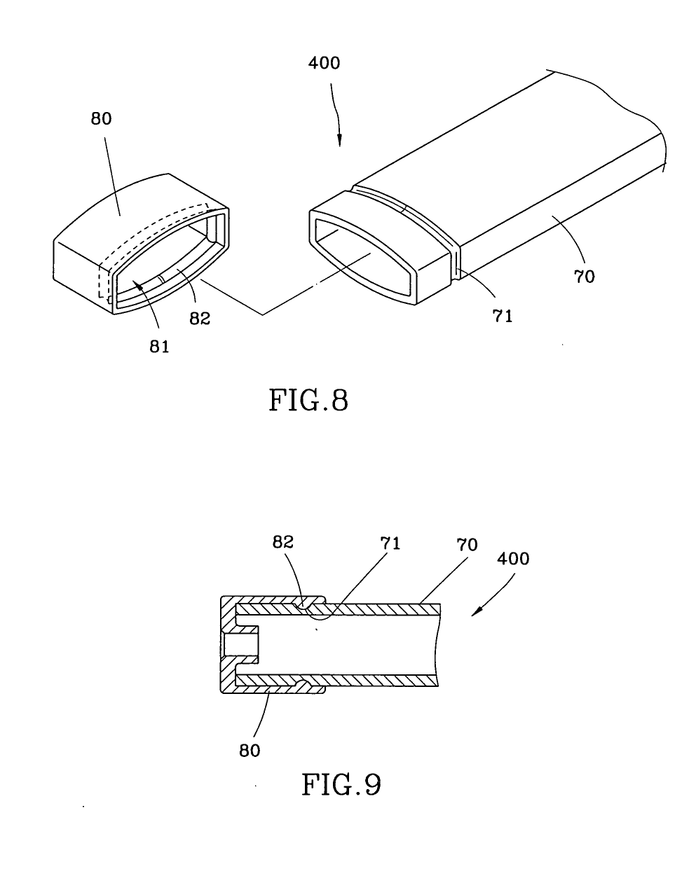

FIGS. 8 and 9 show a bottom rail constructed according to the fourth preferred embodiment of the present invention. According to this embodiment, the bottom rail, which is referenced by 400, is comprised of a body 70 and two end caps 80 (only one end cap 80 is shown in FIGS. 8-9).

The body 70 is an elongated hollow frame bar having two retaining portion 71 near the two distal ends thereof (only one retaining portion and one distal end are shown in the drawings). According to this embodiment, the retaining portions 71 are locating grooves respectively extended around the periphery of the body 70 near the two distal ends.

The end caps 80 each comprise a receiving chamber 81 inwardly extended from one end and fitting the cross section of the body 70, and a retaining portion, namely, an annular rib 82 raised from the inside wall and suspended inside the receiving chamber 81 corresponding to the locating grooves 71 of the body 70. When capped the end caps 80 onto the two distal ends of the body 70, the annular ribs 82 of the end caps 80 are respectively forced into engagement with the locating grooves 71 of the body 70 to secure the end caps 80 to the body 70 firmly.

As indicated above, by means of the engagement between the retaining portions at the body and the retaining portion at the end caps, the end caps are firmly secured to the two distal ends of the body. Although particular embodiments of the invention have been described in detail for purposes of illustration, various modifications and enhancements may be made without departing from the spirit and scope of the invention. Accordingly, the invention is not to be limited except as by the appended claims.

1. A bottom rail for a window blind, comprising:
an elongated body having two distal ends and two retaining portions respectively formed near the two distal ends; and
two end caps respectively fitted to the two distal ends of said elongated body, said end caps each having a retaining portion for engaging the retaining portion of said elongated body upon coupling of said end caps to the two distal ends of said elongated body.

2. The bottom rail for a window blind as claimed in claim 1, wherein said elongated body is an elongated hollow body having an inside wall and a receiving chamber defined by the inside wall and longitudinally extended through the two distal ends thereof; the retaining portions of said elongated body are respectively formed in the inside wall; the retaining portions of said end caps are respectively formed on an outside wall thereof.

3. The bottom rail for a window blind as claimed in claim 2, wherein said end caps each comprise a head respectively stopped against the two distal ends of said elongated body to close said receiving chamber, and an insertion portion perpendicularly extended from said head and respectively fitted into said receiving chamber; the retaining portion of each said end cap is formed on the insertion portion of the respective end cap for engaging the retaining portion of said elongated body upon insertion of the insertion portion of each said end cap into said receiving chamber.

4. The bottom rail for a window blind as claimed in claim 3, wherein the head of each said end cap has a cross section fitting a cross section of said elongated body.

5. The bottom rail for a window blind as claimed in claim 1, wherein said end caps each comprise an inside wall and a receiving chamber defined by the inside wall; the retaining portion of each said end cap is formed in the inside wall; said elongated body has the two distal ends thereof respectively fitted into the receiving chamber of each said end cap; the retaining portions of said elongated body are respectively formed on a periphery of said elongated body and respectively forced into engagement with the retaining portion of each said end cap upon insertion of the two distal ends of said elongated body into the receiving chamber of each said end cap.

6. The bottom rail for a window blind as claimed in claim 1, wherein the retaining portions of said elongated body each comprise at least one retaining hole; the retaining portion of each said end cap comprises at least one protrusion respectively fitting the retaining holes of said elongated body.

7. The bottom rail for a window blind as claimed in claim 1, wherein the retaining portions of said elongated body each comprise at least one protrusion; the retaining portion of each said end cap comprises at least one retaining hole for receiving the protrusions of said elongated body.

8. The bottom rail for a window blind as claimed in claim 1, wherein the retaining portions of said elongated body each comprise a round hole; the retaining portion of each said end cap comprises a rounded protrusion respectively engaged into the round holes of said elongated body.

9. The bottom rail for a window blind as claimed in claim 1, wherein the retaining portions of said elongated body each comprises a rectangular hole; the retaining portion of each said end cap comprises a beveled protruding block respectively engaged into the rectangular holes of said elongated body.

10. The bottom rail for a window blind as claimed in claim 1, wherein the retaining portions of said elongated body each comprise a rounded protrusion; the retaining portion of each said end cap comprises a round hole for receiving the rounded protrusions of said elongated body respectively.

11. The bottom rail for a window blind as claimed in claim 1, wherein the retaining portions of said elongated body each comprise a beveled protruding block; the retaining portion of each said end cap comprises a rectangular hole for receiving the beveled protruding blocks of said elongated body respectively.

12. The bottom rail for a window blind as claimed in claim 1, wherein the retaining portions of said elongated boy each comprise an annular locating groove; the retaining portion of each said end cap comprises an annular rib respectively engaged into the locating grooves of said elongated body.
